(19) United States
(12) Patent Application Publication
(10) Pub. No.: US 2009/0013350 A1
(43) Pub. Date: Jan. 8, 2009

(54) Display of movie titles in a library

(75) Inventors: Keith R. Ohlfs, Redwood City, CA (US); Prasanna Ganesan, Menlo Park, CA (US)

Correspondence Address: SHEMWELL MAHAMEDI LLP;Rong Liu, 4880 STEVENS CREEK BOULEVARD, SUITE 201, SAN JOSE, CA, 95129, US

(73) Assignee: VVOND, LLC

(21) Appl. No.: 11/203,021

(22) Filed: Aug. 11, 2005

(51) Int. Cl. H04N 5/445

(52) U.S. Cl. 725/39

(57) ABSTRACT

Techniques for displaying a library of many movies and providing interactive mechanisms for users to browse the library, select or order a title are disclosed. In one embodiment, movie titles are presented or displayed in movie banners, each resembling at least part or all of a corresponding movie poster distributed and promoted commercially by a studio or production company. Such a movie banner provides an expression with substantially similar style, colors and background such that a coincident impact may be created on audience when the movie banner is seen. Further each of the banners is embedded with a link that leads to a full review of the movie when selected.

### BACKGROUND

1. Technical Field

The present invention relates generally to the display of information on display screens, and more particularly to techniques for displaying and facilitating to browse a large number of movie titles in a library.

2. Description of the Related Art

When television was first introduced, there were a limited number of channels available. There was no electronic means to display programs being offered in all channels. The only browsing mechanism available was a mechanic switch to allow viewers to switch from one channel to another. As technologies have been advanced progressively, digital television, such as satellite and digital cables, has been introduced and now offers a few hundreds of channels. The browsing mechanism has also been improved and now allows viewers to select a particular program much more intelligently. For example, a particular channel or program can be readily determined from a browseble program guide. FIG. 1A shows a program guide 100 offered by Comcast digital cable. The program guide 100 provides a number of categories from which a user may interactively select a desired one. FIG. 1B shows a list 110 of movies that are being shown in respective channels as a result of the user selecting “Action” in the program guide 100 of FIG. 1A. If the use wants to watch one of the movies in the list 110, the desired movie title may be activated.

It is noticed, however, that unless the user is familiar with the movie it is hard for the user to know what the move is about by looking at the title in words. In general, a movie title is in abstract form and does not indicate much literally. When there is a movie library of many titles, there is a great need for displaying the movie titles in a manner that immediately familiarizes viewers with any particular movie being selected.

### SUMMARY

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

Broadly speaking, the present invention is related to techniques for displaying a library of many movies, providing interactive mechanisms for users to browse the library, select or order a title. According to one aspect of the present invention, movie titles are presented or displayed in movie banners, each resembling at least part or all of a corresponding movie poster distributed and promoted commercially by a studio or production company. Such a movie banner provides an expression with substantially similar style, colors and background such that a coincident impact may be created on the audience when the movie banner is seen. Further each of the banners is embedded with a link. Once one of the banners is selected, a full review of the movie is provided.

According to another aspect of the present invention, a full review of the movie includes comprehensive information in one display about the movie to facilitate a user to make a decision. In one embodiment, a full review of the movie includes one or more of a trailer that can be manually or automatically played, a full movie poster and/or a slideshow of certain images from the movie, and a brief description, a rating grade, an exact running time, and a production company of the movie, all in one display.

According to still another aspect of the present invention, a user is allowed to browse the library anytime, even during a show, an iconic display is provided to show what is being played so that the user would not miss any part of the show while performing other tasks. Such an iconic display may be embedded in, superimposed upon or inserted in, whenever or wherever appropriate, a display the user has reached. Depending on implementation, the iconic display may continue or pause the movie being watched. In the case that a movie is paused, the iconic display shows a still image that may be a snapshot of a frame at the time the movie is paused. In a preferable embodiment, the iconic display can be activated to continue the movie in full screen.

According to still another aspect of the present invention, various search methods are provided to facilitate a user to search a desired movie based on genres, directors, main characters, and other movierelated information. In one embodiment, a logic operation is provided to determine a collective search criterion based on multiple criteria. Although it is possible to display results in words, according to one embodiment, movie titles from a search process are shown in movie banners.

According to still another aspect of the present invention, a notification space is provided and used to inform users of various events, updates or commercial promotions. According to one embodiment, the notification space is auctioned among sponsors that hope to display their respective programs to audience. When the notification space is used to promote new releases, full posters of the new releases are distinctly displayed, each being embedded with a link. Once one of the posters is selected, a full review of the movie is provided.

According to yet another aspect of the present invention, a time-fill program is played before an ordered movie is started. Similar to watching a movie in a movie theater, the time-fill program provides a number of previews of upcoming new releases. The time-fill program may be locally configured. In one embodiment, the time-fill program is used to stabilize data being fetched from one or more other devices. In another embodiment, the time-fill program provides a platform for sponsors that hope to display their respective programs to audience. Orders or slot positions for these programs in a time-fill program may be auctioned.

Other aspects of the invention will become apparent and appreciated by those skilled in the art from the detailed description herein. Embodiments of the invention may be implemented in numerous ways, including a method, system, device, or a computer readable medium. Several embodiments of the invention are discussed below. According to one embodiment, the invention provides a method for displaying movie titles in a library, the method comprises displaying on a display screen a home display after a user is authorized to access the library including a plurality of movie titles, the home display including an interactive functional panel and a notification space, wherein the interactive functional panel provides a list of functions from which the user can at least archive some of the movie titles, browse the movie titles, and search or order one of the movie titles. The movie titles are displayed in the form of movie banners in accordance with one of the functions. Further an iconic window is provided to show a movie if there is such a movie that is being played.

According to another embodiment, the invention provides an apparatus for displaying movie titles in a library, the apparatus comprises a memory for storing at least an application module, a processor, coupled to the memory, executing the application module to perform operations of: displaying on a display screen a home display after a user is authorized to access the library including a plurality of movie titles, the home display including an interactive functional panel and a notification space, wherein the interactive functional panel provides a list of functions from which the user can at least archive some of the movie titles, browse the movie titles, and search or order one of the movie titles; displaying the movie titles in movie banners in accordance with one of the functions; and displaying an iconic window showing a movie if there is such a movie that is being played.

Accordingly one of the objects of the present inventions is to provide techniques for displaying and facilitating to browse a large number of movie titles in a library. Other objects, features, advantages, benefits of the invention will become more apparent from the following detailed description of a preferred embodiment, which proceeds with reference to the accompanying drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1A shows a program guide offered by Comcast digital cable;

FIG. 1B shows a list of movies that are being shown in respective channels as a result of the user selecting “Action” in the program guide of FIG. 1A;

FIG. 2A shows an exemplary display showing a list of services provided by a service provider;

FIG. 2B shows an exemplary display, also referred to as a home display, that may be provided after the user enters Watch a Movie of FIG. 2A;

FIG. 2C shows a display including a list of movie titles in My Movies, wherein the movie titles are presented respectively in movie banners;

FIG. 2D shows a display including a viewing history in My Movies to show what movie a user has ordered or watched;

FIG. 3A shows a display including an exemplary full review of a selected movie;

FIG. 3B shows a display that includes an optional panel provided to allow the user to adjust sound control of the trailer being played in a full review of a movie, present additional information about the movie, and enable additional functionality such as the ability to watch the trailer in full-screen mode;

FIG. 3C shows a display including a list of movies conducted by the same director of the movie being reviewed in the full review;

FIG. 4A shows an exemplary display including a browsing panel providing several search schemes to facilitate a search process;

FIG. 4B shows a display after a user chose New Releases and Top Rated in the browsing panel of FIG. 4A;

FIG. 4C and FIG. 4D show respectively a display that provides an alphabetic keypad to allow a user to enter characters or texts to conduct a progressively focused search;

FIG. 5A shows an internal functional block diagram of an exemplary terminal device (e.g., a computing device, a set-top box, and a television); and

FIG. 5B shows a minimum time frame for a time-fill program to run before an order movie starts in a particular terminal device.

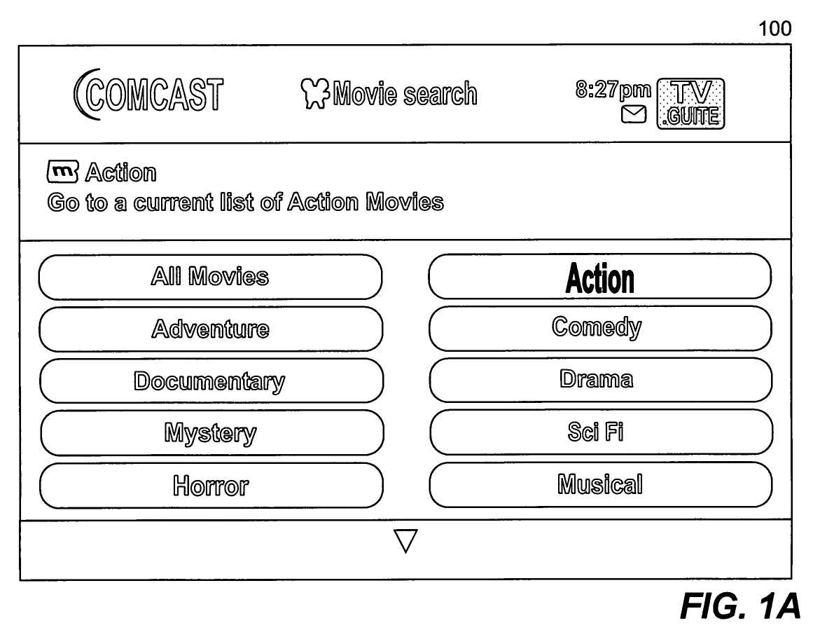

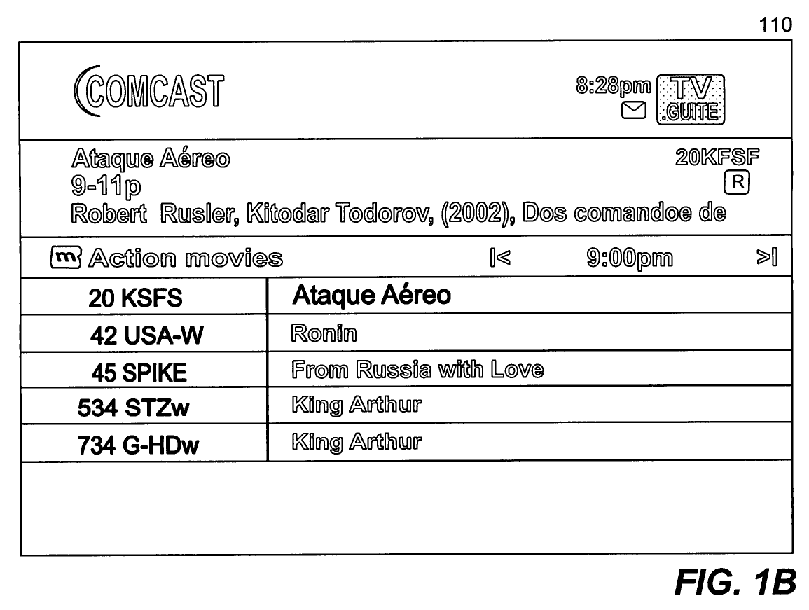

### DETAILED DESCRIPTION OF THE INVENTION

The invention is related to various techniques for displaying a library of many movies, providing interactive mechanisms for users to browse the library, select or order a title. According to one aspect of the present invention, movie titles are presented or displayed in movie banners, each resembling at least part or all of a corresponding movie poster distributed and promoted commercially by a studio or production company. Such a movie banner provides an expression with substantially similar styles, colors and background such that a coincident impact may be created on the audience when the movie banner is seen. Each of the banners is embedded with a link. Once one of the banners is selected, a full review of the movie is provided or a slideshow of certain images from the movie is provided. Different from a prior art system, a full review of a movie in the present invention includes one or more of a trailer that can be manually or automatically played, a full movie poster or a slideshow of certain images from the movie, and a brief description, a rating grade, an exact running time, and a production company of the movie, all in one display. Other aspects, features, benefits and advantages of the invention will become apparent from the following detailed description taken in conjunction with the accompanying drawings which illustrate, by way of example, the principles of the invention.

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments, if any, do not inherently indicate any particular order nor imply limitations in the invention.

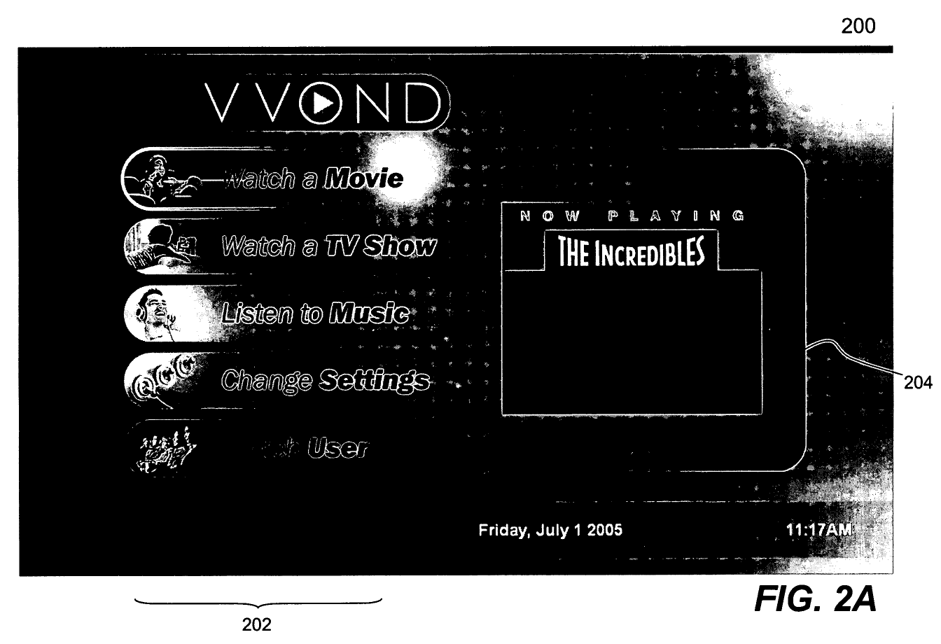

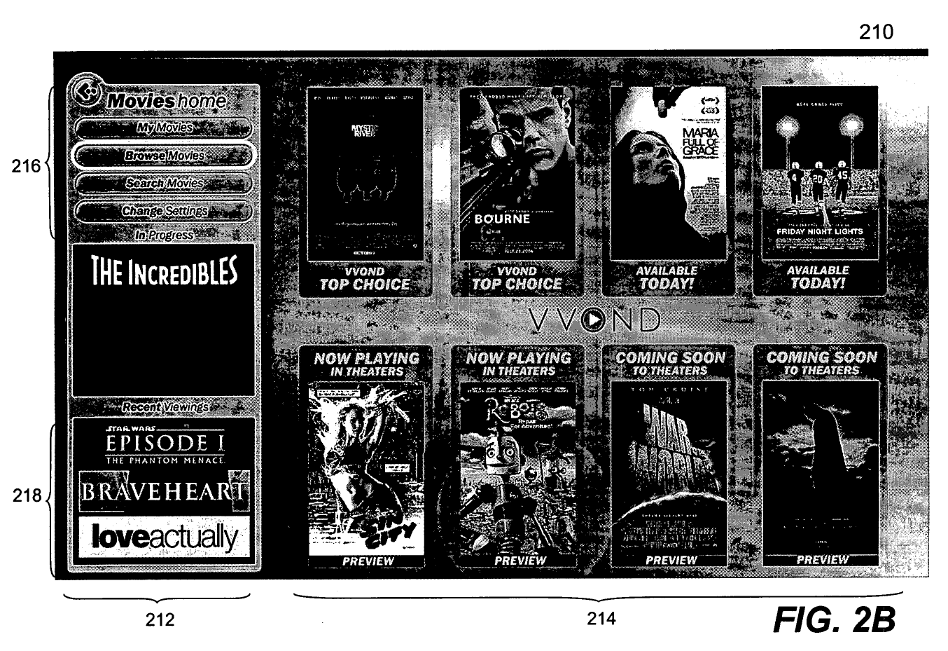

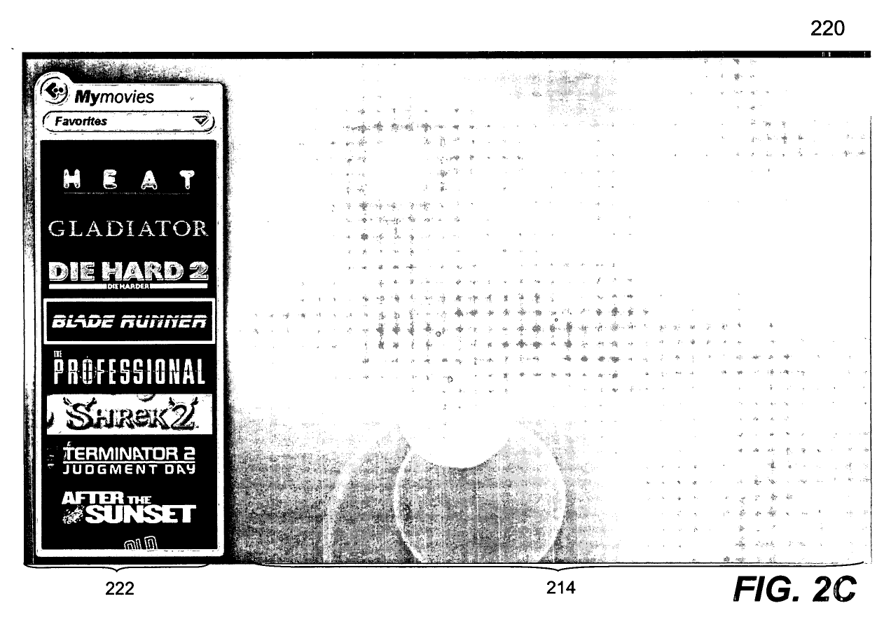

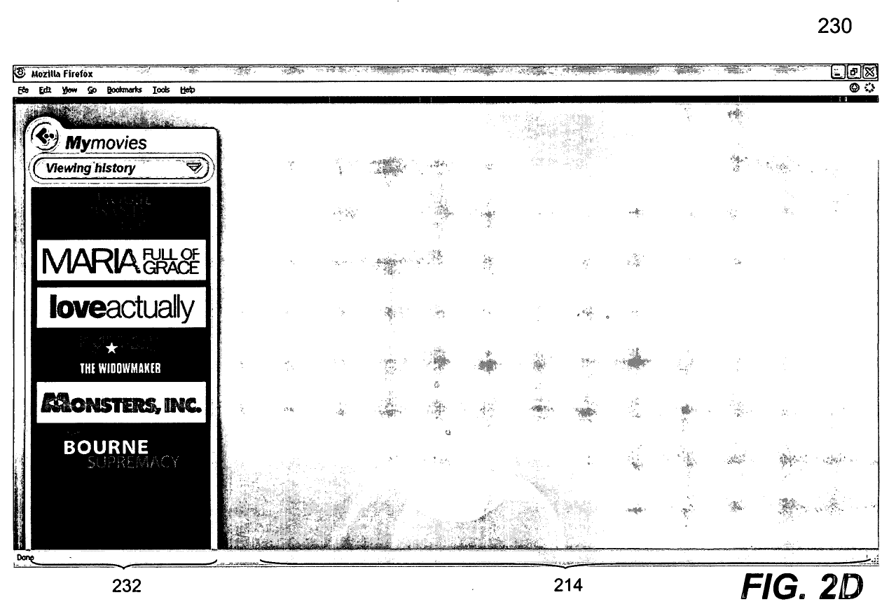

Referring now to the drawings, in which like numerals refer to like parts throughout the several views. FIG. 2A shows an exemplary display 200 providing a list 202 of services provided by a service provider. The display 200 and any subsequent displays are images displays on a display screen that may be part of a computing device or a television, or coupled to a device. It should be noted that it is defined herein a display screen or a screen is a physical display apparatus such as a CRT or LCD television commonly seen and available. A screen display or simply a display is a displayed image or a displayed window presented on the display screen.

The display 200 shows that a user may enter into any of five areas: Watch a Movie, Watch a TV Show, Listen to Music, Change Settings, and Switch User. As the name suggests, Watch a Movie allows a user to order a movie from a plurality of titles in a library, Watch a TV Show and Listen to Music allow a user to choose a particular channel for TV broadcasts and music, live or archived, Change Settings is provided to change various settings for a particular account from which a user may access the services, and Switch User allows a change from one user account to another. Some of the areas will be detailed below.

Next to the list 202, according to one embodiment, the display 200 includes a smaller display window 204, referred to as an iconic display, showing whatever is being played. The iconic display 204 is created when a user leaves a movie being watched for something else. There are situations in which the user decides to go back to the list 202 (e.g., change a setting or order a different movie). Depending on implementation, the iconic display 204 may continue or pause the movie being watched. In the case that a movie is paused, the iconic display shows a still image that may be a snapshot of a frame at the time the movie is paused. By providing the iconic display 204, the user is reminded of what is being played and can always go back to the show by, for example, clicking on the iconic display 204 to go for full screen. It can be understood that such an iconic display, when appropriate, may be placed on a display whenever a user switches to the display in the middle of the playback of a movie. An activation of the iconic display leads to a restoration of a full display of the movie.

It is assumed that a user enters Watch a Movie. FIG. 2B shows an exemplary display 210, also referred to herein as a home display, after the user enters Watch a Movie. The display 210 includes a functional panel 212 and a notification space 214. The functional panel 212 includes various tools 216 to facilitate a user to manage personalized lists and/or minor accounts if necessary, search a movie and change settings, etc. In addition, the functional panel 212 includes a list of recent movies 218 that the user has viewed. In accordance with FIG. 2A, the movie that is currently being played is displayed in an iconic display 220 that is also included in the functional panel 212.

The notification space 214 is provided to display various promotions. The embodiment as shown in the display 210 shows that there are eight movies being promoted. In another embodiment, the notification space 214 is used to advertise various services and products. These services and products may be highly related to the interests or characteristics of the account owner. When an account is established for the owner, a list of questions may be posed for the owner to answer. The answers from the owner to the questions are assembled and analyzed to determine the interests or characteristics of the owner. For example, some answers indicate that the owner is very much into golfing, the notification space 214 may be configured to display services and products somehow related to golfing. The interests or characteristics of the owner may also be determined from an analysis of the owner's behavior in interacting with the system, together with additional information provided to the system about the behavior of other owners.

According to one embodiment, the notification space 214 provides a platform for businesses to promote or advertise their respective services and products. According to one embodiment, the use of the notification space 214 or the selection of programs to be displayed in the notification space 214 may be determined through an auction process. In others words, a business willing to pay a higher price gets a higher priority to display its service/products in the notification space 214.

As shown in FIG. 2B, the movies being promoted in the notification space 214 are in the form of movie posters. One of the advantages of showing movie posters instead of titles in words is to make a coincident impact on audience as a movie poster is a single visual image representation of a movie. Movie studios or production companies, large or small, promote their movies with movie posters so that the general audience gets to know a movie quickly from a corresponding movie poster. According to one implementation, each of the displayed movie posters in the notification space 214 is embedded with a link. Once one of the displayed movie posters is selected, a full review of the movie is provided.

Different from a prior art system that displays limited information about a movie (e.g., www.movielink.com), a full review of a movie in the present invention provides comprehensive information about the movie to facilitate a user to make a decision. According to one embodiment, a full review of the movie includes a trailer that can be manually or automatically played, a full movie poster and a brief description, a rating grade, an exact running time, a production company of the movie, all in one display. An example of such a full preview will be provided herein and described below.

My Movies, Browse Movies, and Search Movies in the functional panel 212 provide respective mechanisms for a user to locate a movie. My Movies is a personal directory providing a vault to store or bookmark one or more movies favorite to the owner of the account. According to one embodiment, when a user is interested in a movie when browsing the library offered, the movie may be bookmarked in My Movies so that the user can always go back to My Movies to readily place an order for the movie. FIG. 2C shows a display 220 including a list 222 in My Movies. Instead of using words for a title of a movie, the display 220 shows a list of movie banners, each banner representing a visual image of the movie. A movie banner may be part of a corresponding movie poster or a redesigned banner that reflects certain characteristics of the movie.

As shown in the list 222 in My Movies, each of the movie banners shows a title in substantially similar style, font and background as in the corresponding movie poster. It may be appreciated by those skilled in the art that one of the features in the present invention is to create a coincident impact on the audience by using at least part of a movie poster or banner to indicate a movie. In certain aspect, a movie banner is equivalent to a visual “logo” for a movie. A user may browse or scroll the list of movie banners in the list 222. Each of the movie banners in the list 222 is embedded with a link that brings up a full review of the movie when one of the displayed movie banners is selected.

According to one embodiment, after a certain arrangement with the service provider is made, the user may gain a limited right to access one or more movies in My Movies repeatedly without repeated charges or with a nominal change. Depending on implementation, the titles in My Movies may or may not be subject to library updating. In operation, a service provider may update the titles in a library periodically or at a predefined time. When the library is updated, the title bookmarked in My Movies may be affected depending on whether the title is still in the updated library. If the title bookmarked in the My Movies is no longer supported by the updated library, the titles in My Movies may be updated accordingly such that whatever bookmarked in My Movies is always in the library. According to another embodiment, some titles in My Movies are independent from the library in which case a special arrangement has to be made with the service provider to make the data pertaining to the titles available to the user for a predefined period.

FIG. 2D shows a display 230 including a viewing history 232 in My Movies. The viewing history 232 is provided to record what movie the user has ordered or watched. Similar to the favorite list 222 in FIG. 2C, the viewing history 232 shows a list of movie banners reflecting that these movies have been watched or ordered. Each of the movie banners in the list 232 is also embedded with a link that leads to a full review of the movie when activated.

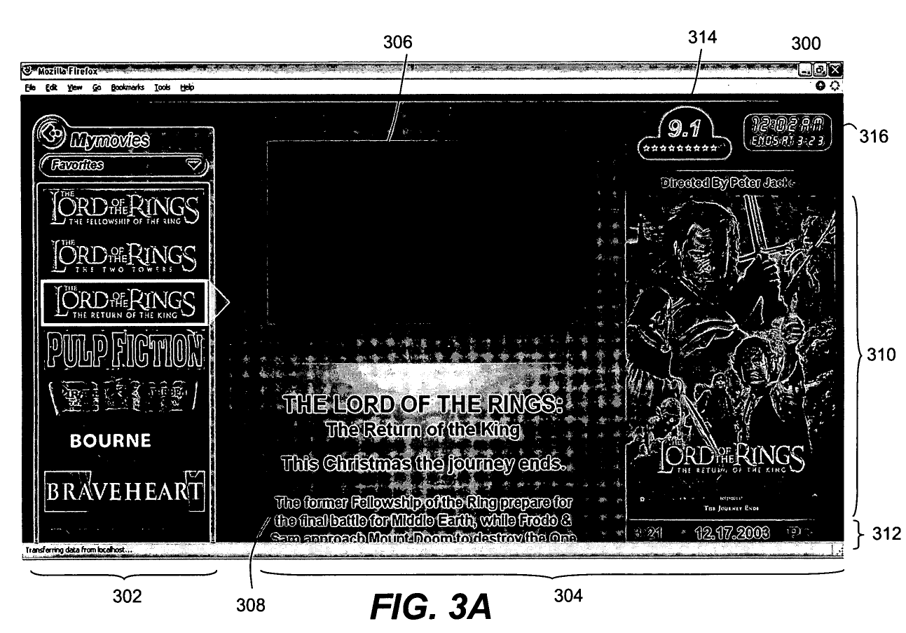

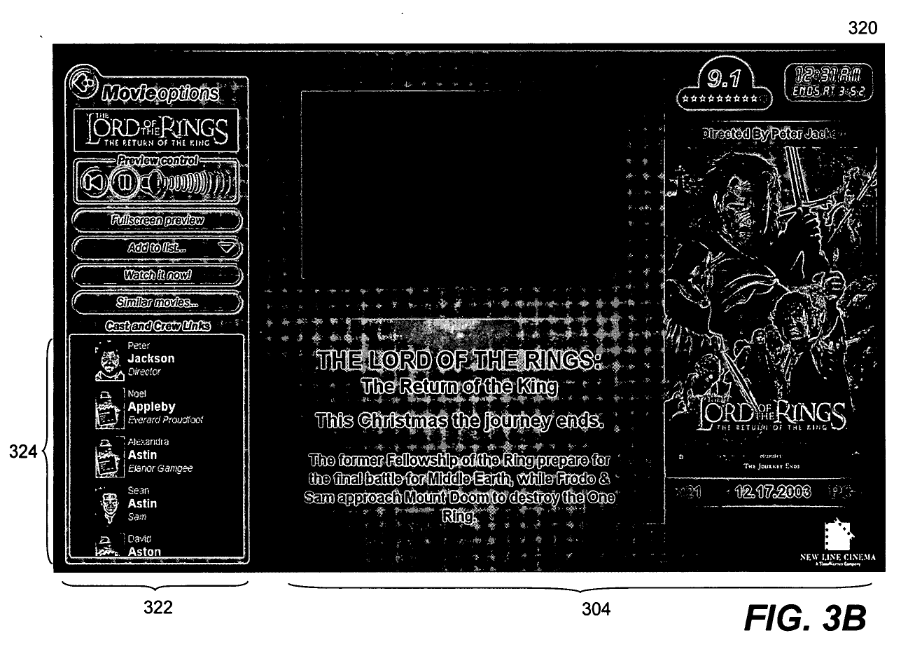

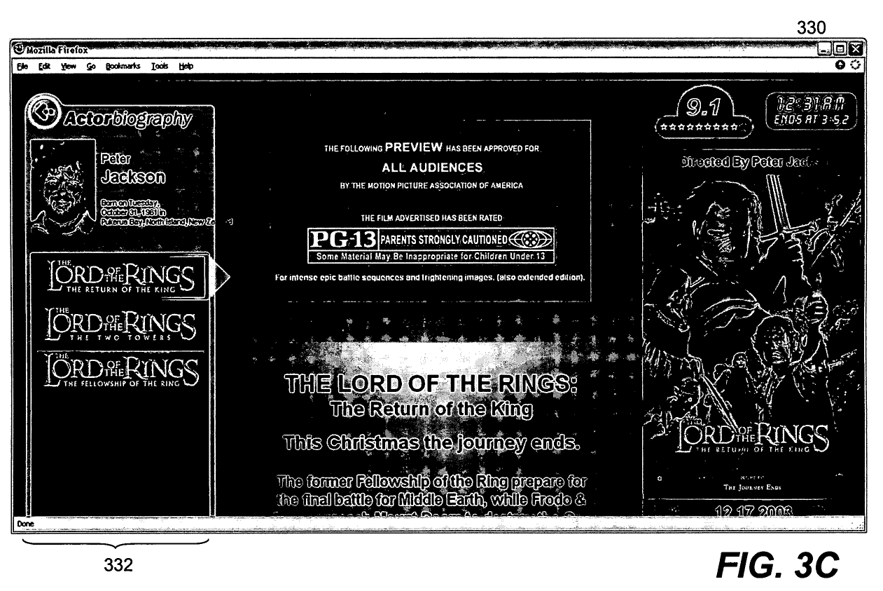

Referring now to FIG. 3A, there shows a display 300 including an exemplary full review 304 of a selected movie. A full review can be displayed whenever a user wants to know something about the movie, for example, a user selects a movie banner in a viewing history 232 of FIG. 2D or a movie poster in notification space 214 of FIG. 2B. FIG. 3A shows that a movie banner in my favorite list 302 is selected. The full review 304 includes a trailer 306 that can be manually or automatically played, a brief description 308 of the movie, a corresponding movie poster 310, and publication information 312 that includes an exact playing time, a publication date and a rating grade. In addition, the full review 304 includes a rating by viewers who have watched the movie and a current time and an ending time if the movie is ordered at the time. One of the features of the full review 304 is that various pieces of information about a movie are integrated in one display so that a user gets to know the movie by one click. According to another embodiment, a full review (not shown) is an interactive page using at least some or all of a corresponding movie poster as the background. Some texts, graphics or icons may be embedded with a corresponding link that brings up a display with more information if activated. For example, a director name in the full review may be activated to bring up a display similar to the one shown in FIG. 3C which will be described below. In addition, such a full review includes a window to show a corresponding trailer or preview. The window may be superimposed on or inserted in wherever appropriate in the background.

FIG. 3B shows a display 320 that includes an optional panel 322. The optional panel allows the user to adjust sound control of the trailer in the full review 304. If the user wants to have a full screen of the trailer, a button Fullscreen preview in the optional panel 322 may be activated. Optionally a designated button on a controller (e.g., remote control) may be pressed. When the user decides to add this chosen move to his/her favorite list, a button Add to list in the optional panel 322 can be activated. As a result, a corresponding movie banner is added to the favorite list, an example of which is shown in FIG. 3A. Should the user decide to order or play back the movie in the full review 304, a button Watch it now in the optional panel 322 may be activated. In operation, when the button Watch it now is activated, the movie is to be played in full screen assuming a type of arrangement (e.g., a payment) has already been made with the service provider. Depending on implementation, after Watch it now is activated, the ordered movie may be started immediately or a time-fill program typically short in time is played before the movie starts. Once the movie is finished, an option may be displayed to allow the user to rent the movie for an extended period or purchase an ownership of the movie, in either case a corresponding movie banner may be placed in my favorite list 302, a personalized list or a list for a personal vault.

To help the user browse in the library that includes many movie titles, the optional panel 322 offers cast and crew links 324. Instead of showing the director, main actors or other characters in words, iconic images about the director, main actors or other characters of the movie in the full review are shown such that the user gets to know these people visually. In one of the embodiments, each of the iconic images is embedded with a link. When one of the iconic images is selected, the underlying link brings up a relevant display about the person. For example, the iconic image for the director Peter Jackson is activated, a display with a brief biography is displayed. FIG. 3B shows an exemplary display 330 including all movies in the library directed by the director Peter Jackson. The list in the panel 332 shows movies directed by the director Peter Jackson. Selecting a movie in this list will also lead to the full review of that movie, thus resulting in an encyclopedic environment where it is possible to jump from movie to actor/director or vice versa in a seamless fashion. It should be noted that various displays pertaining to an iconic image may be possible or designed to get enough attention from the user. Other possible relevant displays include a detailed biography of the director or a website. Similarly, any iconic image for one of the main actors may be activated as well.

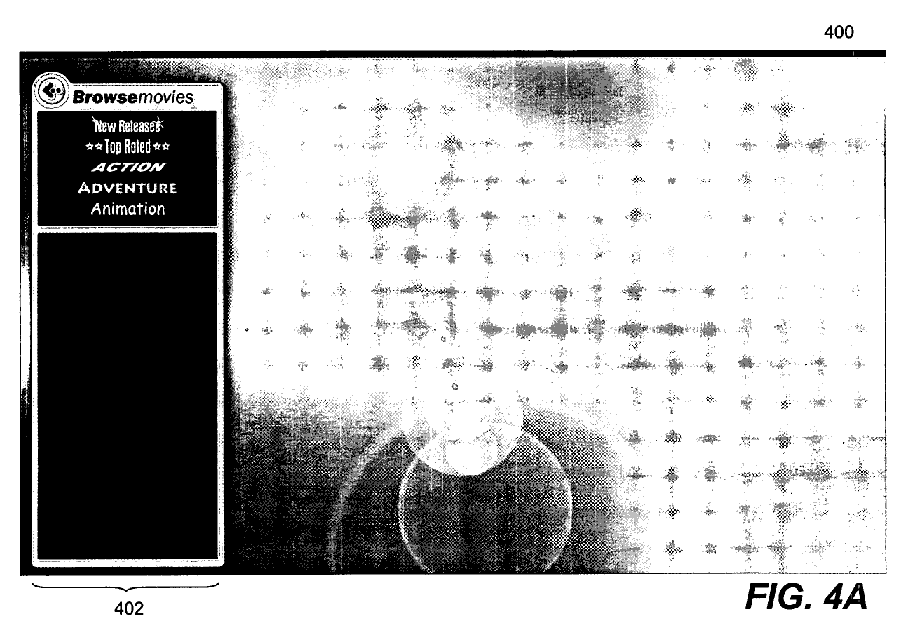

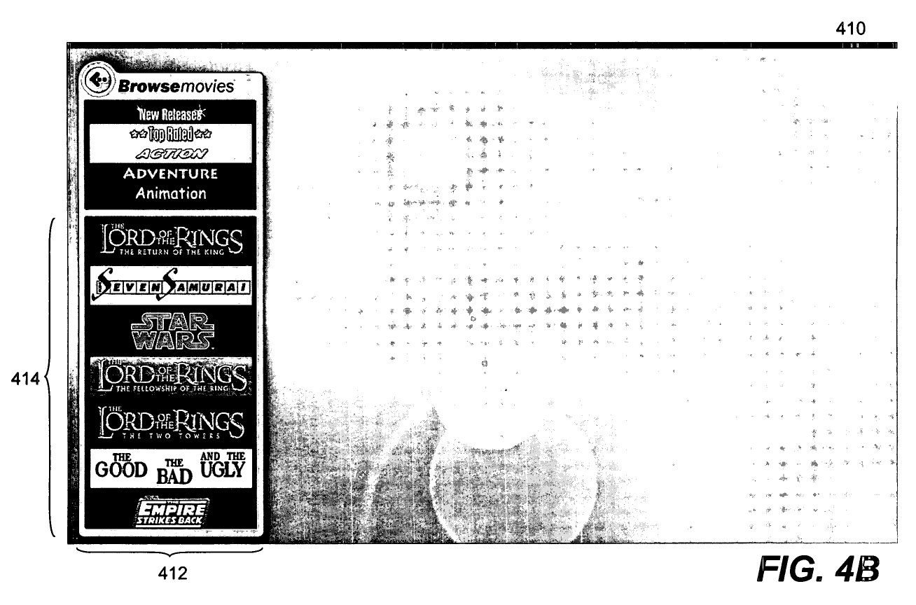

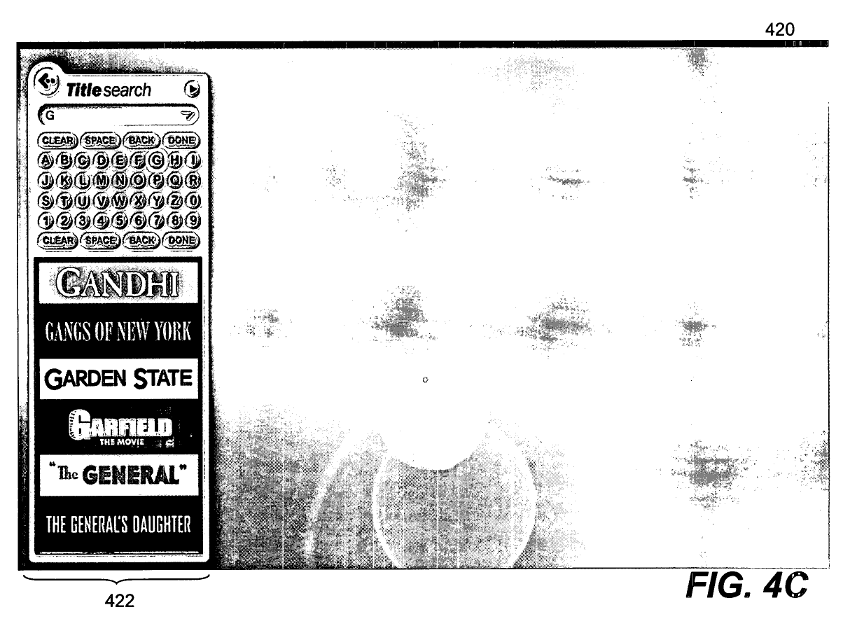

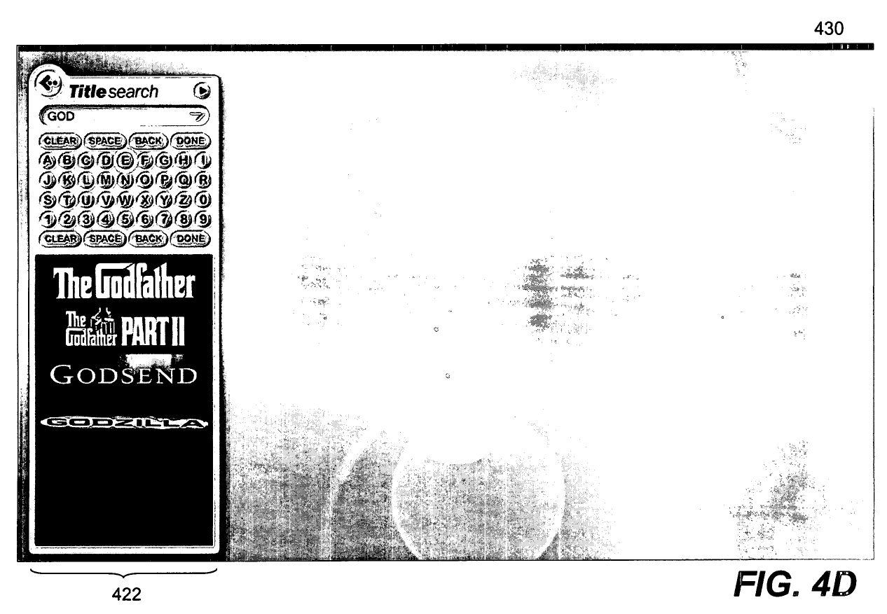

Browse Movies is an interactive mechanism to allow a user to find a movie. Unlike a prior art system in which a user needs to remember a name of a movie, the interactive browsing mechanism according to one embodiment of the present invention provides a number of visual searching tools to help a user to quickly locate what he or she wants. Referring to FIG. 4A, there shows an exemplary display 400 including a browsing panel 402. There are several search schemes that may be provided. According to FIG. 4A, the browsing panel 402 provides searching in a library based on a type or genre of movies. Movie types would include options such as New Releases, Top Rated, '90s movies, '80s movies, oldies, etc. . . . Movie genres may include examples such as Action, Adventure, Animation, Drama, etc. In one embodiment, a logic operation is provided to determine a collective search criterion based on multiple criteria, for example, multiple genres and types provided to lead to a display of titles that match all the genres and types.

FIG. 4B shows a display 410 after a user chose two criteria New Releases and Top Rated in the browsing panel 402 of FIG. 4A. The display 410 shows a list of movies that match both the criteria of New Releases and Top Rated. The display 410 also includes a result panel 414 that shows the list of movies in respective movie banners. When the result panel 414 can not accommodate all the movie banners, the result panel 414 is configured automatically to be scrollable. In other words, a user may scroll, continuously or page by page, a panel to view all titles listed. In addition, the titles in the panel may be sorted by rating, year or alphabetically.

In operation, the list of movies in New Releases, Top Rated or the result panel 414 is subject to change. Whenever a library being offered is updated, the list of movies is updated. As a result, titles labeled by New Releases or Top Rated may change as well. According to one embodiment, each of the movie banners in the result panel 414 is embedded with a link. When one of the movie banners is activated, the underlying link brings up a full review of the movie.

FIG. 4C shows a display 420 that provides another search mechanism. The search panel 422 provides an alphabetic keypad 424 to allow a user to enter characters or texts sequentially. The movies with titles matching the inputted characters or texts partially or completely are displayed in the result panel 426. As shown in FIG. 4C, a first character “G” is selected, thus movies with titles having the character “G” are selected and corresponding movie banners are displayed in the result panel 426.

As the user inputs more characters, the search becomes more focused. Accordingly, the list in the result panel 426 becomes progressively reduced. When the second character the user has inputted is “O”, the movies with titles that do not match the characters “GO” will be removed from the result panel 426. FIG. 4D shows a display 430 after the user has inputted three characters “GOD” which resulted in four movies in the result panel 426.

Unlike the characters in a word, there is no specific order as far as words are concerned. To reach all movies possible, according to one embodiment, there is no specific order of the word inputs with respect to the title. A user may input “Love How” or “How Love” in either which case the movie “Dr. Strangelove or: How I Learned to Stop Worrying and Love the Bomb” will be listed in the result panel 426.

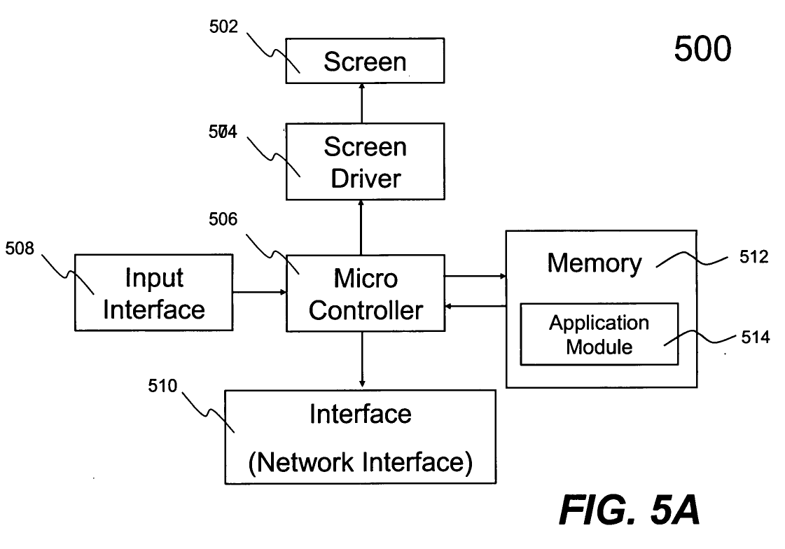

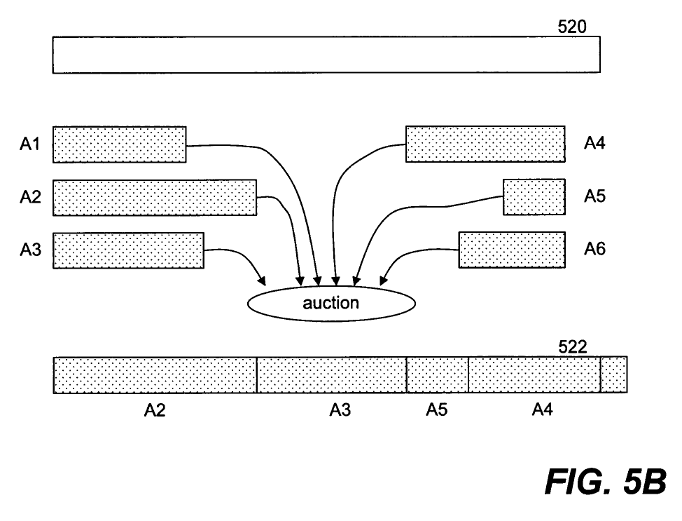

Now referring to FIG. 5, there shows an internal functional block diagram of an exemplary terminal device 500, which may correspond to a computing device, a set-top box, and a television. The screen 502 may be a LCD screen or part of a device (e.g., a television). The screen 502 communicates with and is commanded by a screen driver 504 that is controlled by a microcontroller (e.g., a processor) 506. The memory 512 may be loaded with one or more application modules 514 that can be executed by the microcontroller 506 with or without a user input via the user interface 508 to achieve desired tasks.

In one embodiment, an application module loaded in memory 512 is configured to facilitate a search throughout the movie titles in a library in accordance with characters or words received from the input interface 508 that supports various input devices implemented in hardware or software. Examples of such input devices include a keyboard, an alphabetic keypad, a remote controller, a voice-command controller, or a tracking or scrolling mechanism. In operation, when a user elects to display a search panel, the microcontroller 506 executes the application module to facilitate a search process. In reference to FIG. 4C, an interactive alphabetic keypad is provided and displayed on the screen 502 via the screen driver 504.

According to another embodiment, an application module loaded in memory 582 is configured to facilitate various payment operations. In one exemplary operation, the application module controls the access to a title in a library and allows the access only when the application module is notified or ensured that a payment is settled with a business entity (e.g., the service provider).

According to still another embodiment, an application module loaded in memory 582 is configured to assemble a time-fill program before the start of a movie. As the name suggests, a time-fill program, typically short in time, may be used to inform users of various events, updates or commercial promotions. Depending on implementation, a time-fill program may be assembled differently from one service provider to another. As an example, FIG. 5B shows a time frame 520 for a time-fill program for a particular terminal device. The time frame 520 defines a minimum time the device needs to stabilize data that is being collected or streamed in for playback of an order. It is assumed that there are six commercial programs A1, A2, A3, A4, A5 and A6 that are locally available for assembling the time-fill program. To convey the information efficiently, the programs may be different in length. Given the time frame 520, it is not likely to put all of the six programs in the time-fill program. According to one embodiment, an auctioning mechanism is provided to allow sponsors of these programs to decide when and how their programs are shown to a user. The service provider may determine a respective price for each of the slots in the time-fill program. Typically the first slot is the most expensive as a program gets most attention from a user after the user has just placed an order.

FIG. 5B shows that the sponsors of programs A2, A3, A5 and A4 desire respectively the first slot, the second slot, the third slot and the fourth slot in the time-fill program. It should be noted that the determination or acceptance of a program for the last slot (e.g., the fourth slot) is subject to the time frame 520. In operation, it is not desirable to exceed too much the time frame 520 in order to accommodate all desired commercial programs. The assembled time-fill program 522 in FIG. 5B shows that a small extended time beyond the time frame 520 is added to include a complete program A4.

According to still another embodiment, an application module loaded in memory 582 is configured to track the display or where a movie is being played. Although it is rare in practice, the application module facilitates a speedy recovery or a restart of where the movie had stopped should the terminal device crash.

In addition, the terminal device 500 includes an interface 510 that facilitates wired/wireless communication with one or more other devices. In one embodiment, various commands are sent via the interface 510 (e.g., a RF interface). In another embodiment, some or all of the data pertaining to a movie being chosen to play are fetched from a server or one or more other boxes via the interface 510 (e.g., a network interface).

There may be many mechanisms or methods that may be implemented to interact with the displays described herein. In one embodiment, each of the displays described herein can be arrived, scrolled, browsed or activated by a remote device with a scrolling mechanism (e.g., a wheel). A user may navigate a display or scroll up or down a list by rolling the scrolling mechanism, and activate a link, enter a character or execute a command by pressing the scrolling mechanism, another key or button.

One skilled in the art will recognize that elements of the present invention may be implemented in software, but can be implemented in hardware or a combination of hardware and software. The invention can also be embodied as computer-readable code on a computer-readable medium. The computer-readable medium can be any data-storage device that can store data which can be thereafter be read by a computer system. The computer-readable media can also be distributed over network-coupled computer systems so that the computer-readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, some elements in a display may include one or more sub-elements. When such an element is selected, the display appearance of the element may be highlighted in a way that enables the user to navigate into the sub-elements to select one of the sub-elements or group one or more of these sub-elements. Accordingly, the scope of the present invention is defined by the appended claims rather than the foregoing description of embodiments.

1. A method for presenting movie titles on a display, the method comprising:
displaying a functional panel that enables a user to perform any one of a plurality of actions, including one or more actions to enable the user to browse the movie titles and to search the movie titles for a first movie title;
in response to the user selecting one of the plurality of actions, displaying a list of movie titles associated with the selected action in a first interface of the display; and
concurrently while displaying the list of movie titles, displaying a set of information pertaining to one of the listed movie titles in a second interface of the display, wherein each of the listed movie titles is presented as a graphical image that is selectable by the user.

2. The method of claim 1, wherein each of the graphical images corresponds to at least part of a movie poster.

3. The method of claim 1, wherein each of the graphical images is substantially similar in at least one of: (i) styles, (ii) color, or (iii) background.

4. The method of claim 1, further comprising displaying information about one or more events or commercial promotions.

5. The method of claim 4, wherein displaying information about one or more commercial promotions further comprises displaying a plurality of movie titles being promoted or advertised, each of the plurality of movie titles being presented as a graphical image that is selectable by the user.

6. The method claim 1, wherein displaying information pertaining to one of the listed movie titles comprises displaying a movie review associated with the movie title.

7. The method of claim 5, further comprising, in response to the user selecting one of the movie titles being promoted or advertised, enabling the user to: (i) archive the selected movie title, (ii) request playback of media content corresponding to the selected movie title, or (iii) search for other movie titles based, at least in part, on information pertaining to the selected movie title.

8. The method of claim 6, wherein displaying a full review associated with the movie title includes concurrently displaying at least: (i) a trailer, (ii) a movie poster, (iii) a synopsis, (iv) a rating, (v) a length of playback, and (vi) a production company associated with the movie title.

9. The method of claim 1, wherein the plurality of actions further includes at least one of: (i) organize a personalized list of movie titles, (ii) manage one or more user accounts, or (iii) configure one or more user preferences.

10. The method of claim 4, further comprising determining the one or more events or commercial promotions to be displayed in the notification area based, at least in part, on information collected about the user.

11. The method of claim 4, further comprising determining the one or more events or commercial promotions to be displayed in the notification area based, at least in part on an auction process among a plurality of sponsors.

12. The method of claim 1, further comprising, in response to the user selecting one of the plurality of movie titles:
displaying, in the second interface, a set of information pertaining to the selected movie title;
enabling the user to request playback of media content associated with the selected movie title; and
displaying, in the first interface, a list of actors associated with the selected movie title.

13. The method of claim 12, further comprising, in response to a request for playback of the selected movie title, initiating playback of a time-fill program, wherein the time-fill program includes one or more of: texts, pictures, trailers, previews or commercial information.

14. The method claim 13, further comprising determining the time-fill program based, at least in part, on an auction process among a plurality of sponsors.

15. A system for presenting movie titles on a display, the system comprising:
a processing device coupled to the display, the processing device being configured to display a functional panel having a plurality of user selectable actions presented therein, including one or more actions to enable the user to browse the movie titles and to search the movie titles for a first movie title;
an input device for enabling a user to select one of the plurality of actions presented in the functional panel; and
wherein in response to the user selecting one of the plurality of actions, the processing device is configured to: (i) present on the display a list of movie titles associated with the selected action, each of the listed movie titles being presented as a user-selectable graphical image in a first interface of the display, and (ii) concurrently while displaying the list of movie titles on the display, presenting a set of information pertaining to one or more of the listed movie titles, the set of information being presented in a second interface of the display.

16. The system of claim 15, wherein the input device is a remote device that includes a scrolling mechanism to receive a user input, the scrolling mechanism being provided for enabling the user to scroll and navigate the functional panel and at least one of the first or second interfaces.

17. The system of claim 15, wherein each of the graphical images corresponds to at least part of a published movie poster.

18. The system of claim 15, wherein each of the graphical images is substantially similar in at least one of: (i) styles, (ii) color or (iii) background.

19. The system of claim 15, wherein the processor is further configured to display information about one or more events or commercial promotions.

20. The system of claim 19, wherein the information about one or more events or commercial promotions includes a plurality of movie titles being promoted or advertised, each of the plurality of movie titles being presented as a graphical image and that is selectable by the user.

21. The system of claim 15, wherein the scrolling mechanism enables the user to perform a plurality of actions, including at least: (i) scroll through a list of movie titles, (ii) activate a link, (iii) input one or more characters, and (iv) execute a command.

22. A method for presenting movie titles on a display, the method comprising:
displaying a list of movie titles in a first interface of the display, wherein each of the movie titles is selectable by a user;
wherein in response to the user selecting one of the plurality of movie titles, the method further comprises:
displaying a set of information pertaining to the selected movie title in a second interface of the display;
displaying, in the first interface of the display, a set of user-selectable actions to be performed on the selected movie title, including an action for enabling the user to request playback of a movie corresponding to the selected movie title; and
concurrently while displaying the set of actions, presenting a list of personnel associated with the selected movie title in the first interface of the display.

23. The method of claim 22, wherein the personnel include one or more of: actors, directors, or crew members involved with the corresponding movie.

24. The method of claim 22, wherein the list of personnel is presented as a plurality of graphical images that are selectable by the user, each of the plurality of graphical images including at least a portrait of a corresponding person.

25. The method of claim 24, wherein in response to the user selecting one of the personnel, displaying a list of movie titles associated with the selected personnel.

26. The method of claim 25, wherein displaying a list of movie titles associated with the selected person comprises:
displaying the list of movie titles in the first interface of the display, wherein each of the movie titles is presented as a graphical image that is selectable by the user; and
displaying, concurrently, a set of information pertaining to one of the listed movie titles in the second interface of the display.
